(19) United States
(12) Patent Application Publication
(10) Pub. No.: US 2010/0058726 A1
(43) Pub. Date: Mar. 11, 2010

(54) INTERCHANGEABLE ELECTRIC MOTOR FOR POWERED GARDEN IMPLEMENTS

(76) Inventors: John Arthur Notaras, New South Wales (AU); Angelo Lambrinos Notaras, New South Wales (AU)

Correspondence Address: PILLSBURY WINTHROP SHAW PITTMAN, LLP, P.O. BOX 10500, MCLEAN, VA, 22102, US

(21) Appl. No.: 12/531,995

(22) PCT Filed: Mar. 4, 2008
(86) PCT No.: PCT/AU08/00291

§ 371 Date: Oct. 29, 2009

(30) Foreign Application Priority Data
Mar. 20, 2007 (AU) 2007901432

(51) Int. Cl. A01D 34/00; B23P 11/00; H02K 7/14

(52) U.S. Cl. 56/10.1; 29/428; 310/67 R; 30/277.4

(57) ABSTRACT

An electric motor sub-assembly with a gear train or drive train and clutch, which replaces a conventional internal combustion engine unit including its conventional clutch. The speed increase or decrease of the gear train is selected so that irrespective of whether an induction or universal electric motor is used, the speed of the clutch substantially replicates the speed of the conventional internal combustion engine clutch. As a consequence, a wide range of implement frames can accept either the internal combustion engine unit or the electric motor sub-assembly to create differently powered implements with a maximum of commonality of parts.

### FIELD OF THE INVENTION

The present invention relates to tillers, cultivators, trimmers, brush cutters, hedgers, lawn edgers, or like garden implements which are normally powered by internal combustion engine. Such implements are generally portable are sold in large numbers, and most households with a garden would have at least one of these implements.

### BACKGROUND ART

Usually, the internal combustion engine is a gasoline engine including a clutch and the entire gasoline engine unit is often manufactured by a different entity from the entity which manufactures the implement.

It is also known to manufacture such implements with an inbuilt electric motor. Such electric motor powered implements do not need a clutch because electric motors start instantaneously and there is no question of idling, the electric motor is simply switched off if no tilling action, trimming action, etc. is required.

However, the sales of electrically powered implements are very much less than the sales of implements having an internal combustion engine. In addition, such electrically powered implements are manufactured as completely different models which mostly have dissimilar components, notwithstanding the same function.

Historically this distinction has been brought about because of the nature of the different operating speeds of the various power plants. For example, a petrol or gasoline engine has an operating speed of typically 6,500-7,000 rpm under load. Since the implement has a throttle control, the operator utilises this to keep the speed of the engine relatively constant and thus depending upon the load either increases or decreases the supply of fuel to the engine.

One type of electric motor is a so called “universal” electric motor, typically in the range of 800-1,300 watts and typically operating at 15,000 rpm at no load. The operating speed of a universal motor slows under load but still remains very high (typically above 13,000-14,000 rpm)

Another type of motor is an induction motor which operates at near synchronous speed with very low slip at low loads, and operates a little slower with an increased slip at higher loads. A two pole induction motor has a synchronous speed of 3,000 rpm for a 50 Hz supply and 3,600 rpm for a 60 Hz supply whilst a four pole induction motor has a synchronous speed of 1,500 rpm for a 50 Hz supply and a synchronous speed of 1,800 rpm for a 60 Hz supply.

This disparity in operating speed means that entirely different gear box arrangements are required in order to convert the electric motor speed to the desired implement speed. This is an important factor which results in electric motor powered implements being different models and lacking common parts relative to internal combustion engine powered implements.

### GENESIS OF THE INVENTION

The genesis of the present invention is a desire to increase the percentage of common parts amongst garden implements, irrespective of the nature of the power plant. In this way, substantial economic savings are available in reducing inventory overhead and also in adjusting manufacturing processes to quickly adapt a production line from manufacturing an implement powered by an internal combustion engine power plant, to manufacturing the same implement powered by an electric motor power plant.

In the future it is thought that increased regulation relating to engine noise, engine pollution, carbon dioxide concerns in the face of global warming, and similar such considerations, will result in a vastly increased, but variable, demand for implements powered by an electric motor.

### SUMMARY OF THE INVENTION

In accordance with a first aspect of the present invention there is disclosed a garden implement comprising a tiller, cultivator, trimmer, brush cutter, hedger, lawn edger or the like, said garden implement having a frame and a rotatable member mounted on said frame for rotation relative thereto, an internal combustion engine unit having an output shaft and being mountable on said frame, and an electric motor sub-assembly mountable on said frame; said garden implement normally being powered by said internal combustion engine unit; said electric motor sub-assembly comprising an electric motor having a motor output shaft, a drive train connected with said shaft and including a gear train and a clutch; said gear train being selected to convert the speed of rotation of said electric motor output shaft to the substantially equivalent speed of rotation of said internal combustion engine output shaft; a housing for said sub-assembly; said electric motor, drive train and electric motor shaft being mounted in said housing; and both said housing and said internal combustion engine unit having a corresponding attachment means to permit said electric motor sub-assembly to be connected with said frame in lieu of said internal combustion engine unit, and to permit said internal combustion engine unit to be connected to said frame in lieu of said electric motor sub-assembly. Preferably the housing includes a switch for the electric motor, thereby making the sub-assembly self contained.

In accordance with a second aspect of the present invention there is disclosed a method of assembling a tiller, cultivator, trimmer, brush cutter, hedger or lawn edger or like garden implement normally powered by an internal combustion engine unit and comprising a frame, and a rotatable member mounted on said frame for rotation by a power plant able to be attached to said frame, said method comprising the step of selecting said power plant from an internal combustion engine unit having an output shaft or an electric motor sub-assembly having an output shaft driven by a gear train selected to convert the speed of said sub-assembly shat to approximately that of said internal combustion engine unit to thereby form the implement.

### BRIEF DESCRIPTION OF THE DRAWINGS

A preferred embodiment of the present invention will now be described with reference to the drawings in which:

FIG. 1 is a perspective view of a prior art edger,

FIG. 2 is a perspective view of a prior art trimmer,

FIG. 3 is a partial perspective view of a prior art tiller or cultivator,

FIG. 4 is a perspective view of the electric motor sub-assembly of the preferred embodiment,

FIG. 5 is an exploded perspective view showing the upper portion of the housing of FIG. 4 removed so as to reveal the interior contents of the housing, and

FIG. 6 is an exploded perspective view of the electric motor sub-assembly of FIGS. 4 and 5.

### DETAILED DESCRIPTION

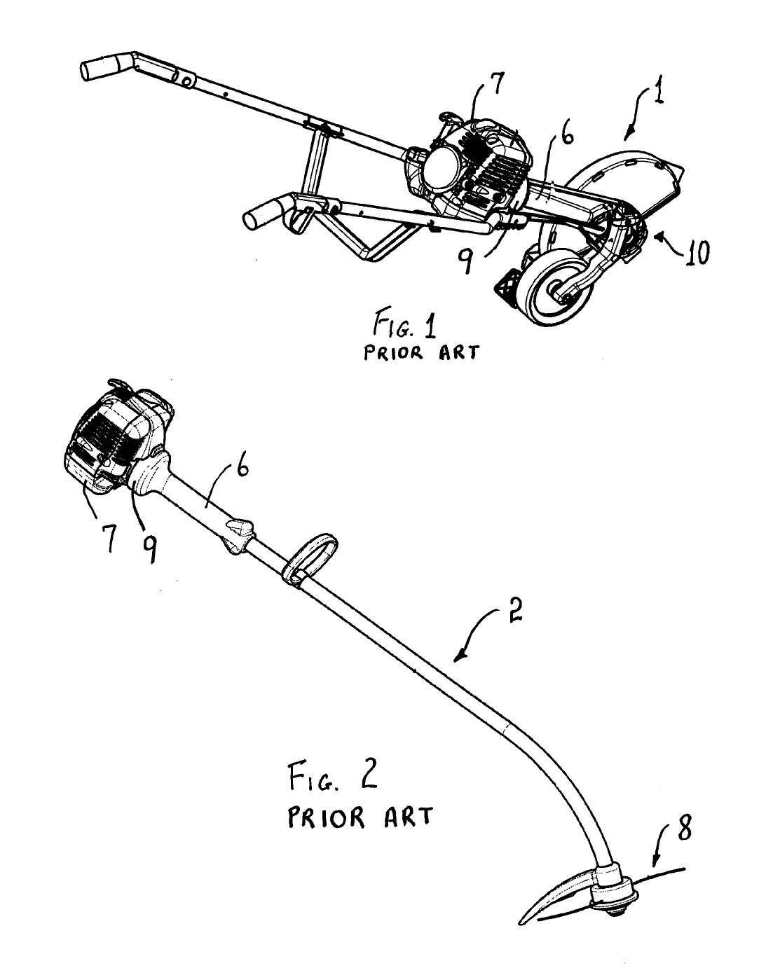

A prior art edger 1 having a frame 6 and an internal combustion engine unit 7 is illustrated in FIG. 1. The cutting blades (not visible in FIG. 1) of the edger 1 rotate at an ideal speed of 2,000-2,200 rpm and thus the speed reduction gearing which is present in the hub 10 is typically a 3.5 to 1 speed reduction. For an electric motor model of the edger 1 incorporating a universal motor, it is necessary to use a different arrangement of reduction gears in the hub 10, in this case having a reduction of approximately 7 to 1, otherwise the blade speed is too high. Conversely, in the event that a 2 pole induction motor is used as the power plant, again the gear arrangements within the hub 10 must be changed so as to provide approximately a 2.5 to 1 speed increase.

Similarly, a trimmer 2 having a frame 6 and being powered by an internal combustion engine unit 7 is illustrated in FIG. 2. The engine unit 7 includes a clutch (not illustrated) and mates with a shroud locking ring 9. Here a direct drive from the engine 7 is used so the cutting filaments 8 rotate at a speed of approximately 6,500-7,000 rpm. If a universal electric motor is used the cutting filament rotates at about 14,000-15,000 rpm which is undesirably high and results in excessive filament wear and the creation of hazardous high speed projectiles. In general an induction motor is too slow for such an implement.

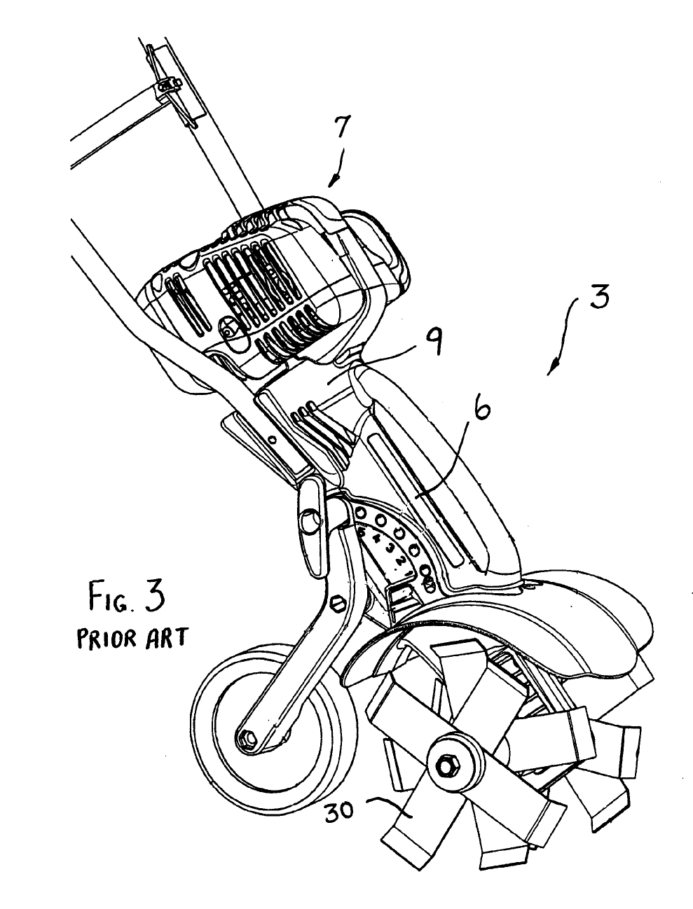

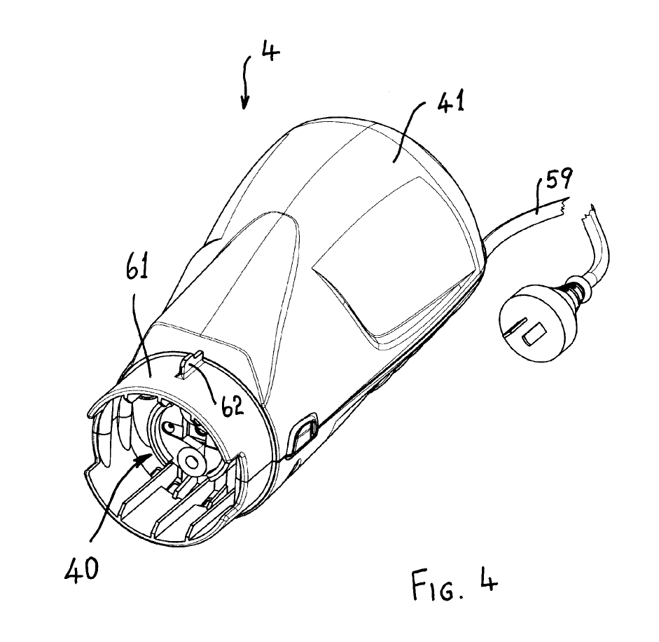

By contrast, as seen in FIG. 3, a tiller or cultivator 3 has tines 30 which rotate at the relatively low speed of 175-200 rpm. The cultivator 3 illustrated in FIG. 3 has a gear box located adjacent the tines 30 and driven by the internal combustion engine unit 7. For the internal combustion engine unit 7 the gear box has a reduction ratio of approximately 40 to 1. However, for a universal electric motor such a tiller gear box requires a reduction ratio of approximately 80 to 1 whilst for a two pole induction electric motor the gear box requires a reduction ratio of approximately 15 to 1.

It follows in view of the above that the different gearing arrangements mean that entirely different models are required for different power plants and that such models cannot have a high degree of commonality of parts.

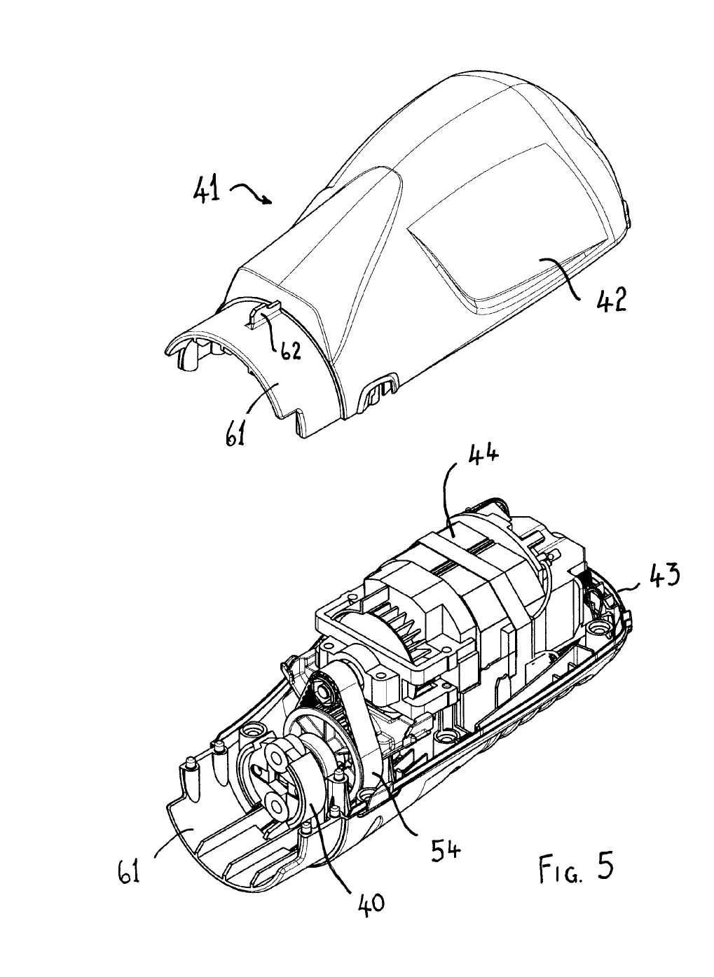

However, the electric motor sub-assembly of the preferred embodiment to be described hereafter in relation to FIGS. 4-6 is based upon the appreciation that if the output thereof is made to emulate the output of the conventional gasoline engine, then the remainder of each of the garden implements can be as for the gasoline engine powered implement, and therefore an essentially complete commonality of parts is automatically achieved.

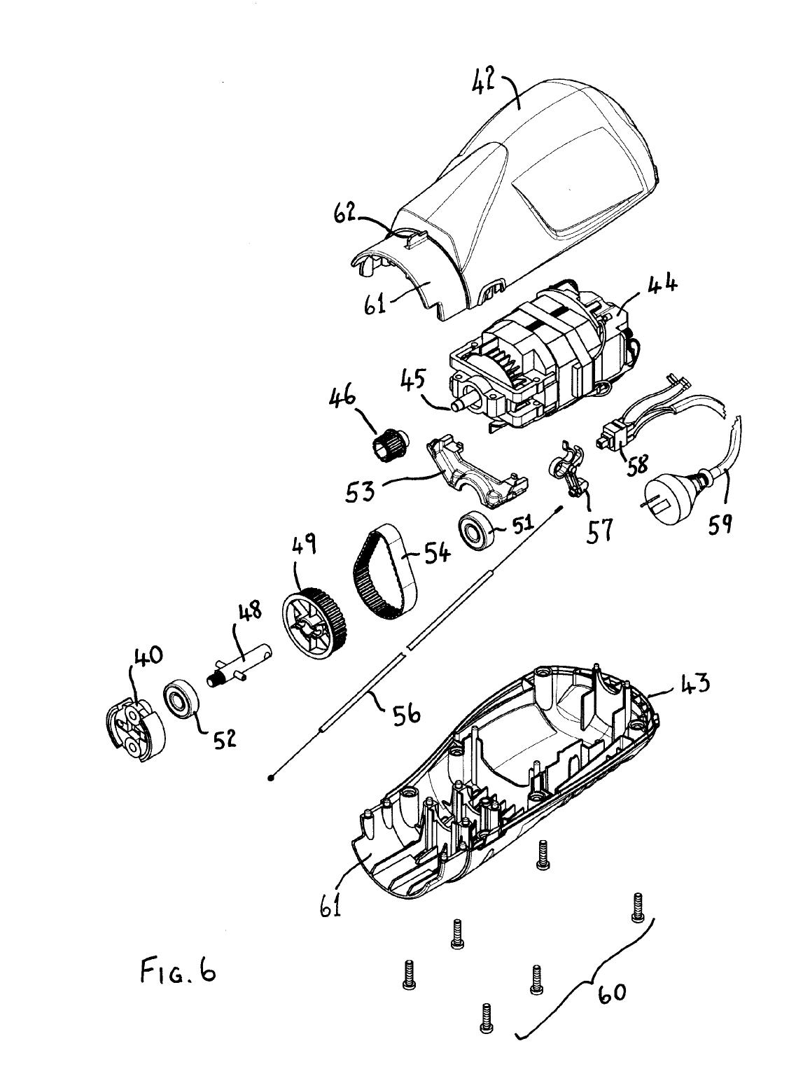

Turning now to FIGS. 4-6, an electric motor sub-assembly 4 is provided having a clutch 40 which replicates the clutch (not illustrated) of the internal combustion engine unit 7 of FIGS. 1, 2 and 3. As best seen in FIGS. 5 and 6, the clutch 40 is contained within a two part housing 41 having a cover 42 and a base 43. Within the housing 41 is located a universal electric motor 44 having a motor output shaft 45.

A first toothed wheel 46 is mounted on the shaft 45. A clutch shaft 48 has the clutch 40 mounted at one end and a second toothed wheel 49 mounted at the other end. Two ball bearings 51, 52 are provided to support the opposite ends of the clutch shaft 48.

The base 43 and cover 42 are arranged to support the bearing 52. A support bar 53 acting together with the base 43, supports the bearing 51. A toothed drive belt 54 interconnects the two wheels 46, 49 to form the gear train and provide the necessary gear train reduction (15,000 rpm to 7,000 rpm approximately or approximately 2 to 1) for the sub-assembly 4.

The implements have a shroud locking ring 9 into which the cylindrical shroud 61 is fully received. The sub-assembly 4 is locked into position by two fasteners (not illustrated) which pass through a corresponding pair of hooked spines 62 (only one of which is illustrated in FIGS. 4-5). These features not only clamp the shroud locking ring 9 to produce a strong clamping effect around the diameter of the shroud 61, but also provide a substantially fail safe anchoring system for the sub-assembly 4 since these fasteners prevent the sub-assembly 4 from being withdrawn from, or rotating relative to, the shroud locking ring 9.

The housing 41 is provided with a hollow cylindrical shroud 61, which contains the clutch 40, and which is the same size as the clutch shroud (not illustrated) which is provided on the internal combustion engine unit 7.

A conventional Bowden cable 56 for the conventional throttle trigger control (not illustrated) of the internal combustion engine unit 7, and which incorporates a safety lock, is used to connect to a switch actuator 57 which operates an electric switch 58. This is the on/off switch for the motor 44. An electric cable 59 and fasteners 60 complete the arrangement. Thus the sub-assembly 4 is completely self contained and does not required an external electric switch mechanism (such as is usually provided as part of a different handle system on electrically powered implements having extended handles).

It will be apparent to those skilled in the art, that if the electric motor 44 is an induction motor rather than a universal motor, then the first toothed wheel would be larger than the second toothed wheel in order for the belt drive gearing to provide the necessary speed increase for the electric motor sub-assembly 4 to again emulate the speed of the conventional gasoline internal combustion engine unit 7. That is, the first and second toothed wheels 46 and 49 are notionally reversed.

A significant advantage of the above described arrangement is that the production line for the edger 1, trimmer 2, or cultivator 3 (or other implements not illustrated) can remain unchanged and a decision can be made in the course of production as to which power plant is to be provided for the final implement. If an internal combustion engine unit 7 is required, then this is connected to any frame 6. However, if an electric motor is required, then the electric motor sub-assembly 4 is connected to that frame 6 instead. Thus any frame 6 can receive either power plant. As a consequence, production can be rapidly shifted from one type of power plant to another and without interfering with the remainder of the production line, or the remainder of any implement (ie other than the power plant).

Similarly, operators who use these implements can change the power plant to suit the circumstances of use. For example, where no electric power is available the internal combustion engine unit 7 can be used, and in closely built neighbourhoods the electric motor sub-assembly 4 can be simply installed to reduce noise pollution. Thus a tradesman with two power plants and a single frame 6 effectively has two differently powered machines.

The foregoing describes only one embodiment of the present invention and modifications, obvious to those skilled in the garden implements arts, can be made thereto without departing from the scope of the present invention. For example, it will be understood that for a hedger having oscillating blades, the rotatable member mounted on the frame 6 is the rotary drive for the oscillating blades. Similarly, the gear train formed by belt 54 and wheels 46, 49 can be substituted by a belt and two pulleys, or by a gear box.

The term “comprising” (and its grammatical variations) as used herein is used in the inclusive sense of “including” or “having” and not in the exclusive sense of “consisting only of”.

1. A garden implement comprising a tiller, cultivator, trimmer, brush cutter, hedger, lawn edger or the like, said garden implement having a frame and a rotatable member mounted on said frame for rotation relative thereto, an internal combustion engine unit having an output shaft and being mountable on said frame, and an electric motor sub-assembly mountable on said frame; said garden implement normally being powered by said internal combustion engine unit; said electric motor sub-assembly comprising an electric motor having a motor output shaft, a drive train connected with said shaft and including a gear train and a clutch; said gear train being selected to convert the speed of rotation of said electric motor output shaft to the substantially equivalent speed of rotation of said internal combustion engine output shaft; a housing for said sub-assembly; said electric motor, drive train and electric motor shaft being mounted in said housing; and both said housing and said internal combustion engine unit having a corresponding attachment means to permit said electric motor sub-assembly to be connected with said frame in lieu of said internal combustion engine unit, and to permit said internal combustion engine unit to be connected to said frame in lieu of said electric motor sub-assembly.

2. The implement as claimed in claim 1 wherein said attachment means comprises a hollow cylinder which is substantially concentric with said clutch.

3. The implement as claimed in claim 1 wherein said electric motor is a universal motor and said gear train reduces the rotational speed of said motor output shaft.

4. The implement as claimed in claim 1 wherein said electric
motor is an induction motor and said gear train increases the rotational speed of said motor output shaft.

5. The implement as claimed in claim 1 wherein said housing is fabricated in two opposing parts each of which provides a bearing support means for said motor and drive train.

6. The implement as claimed in claim 1 wherein said housing includes a switch for said electric motor.

7. The implement as claimed in claim 6 and selected from the class consisting of a tiller or cultivator, a brush cutter, a hedger, a lawn edger, and a trimmer.

8. A method of assembling a tiller, cultivator, trimmer, brush cutter, hedger or lawn edger or like garden implement normally powered by an internal combustion engine unit and comprising a frame, and a rotatable member mounted on said frame for rotation by a power plant able to be attached to said frame, said method comprising the step of selecting said power plant from an internal combustion engine unit having an output shaft or an electric motor sub-assembly having an output shaft driven by a gear train selected to convert the speed of said sub-assembly shat to approximately that of said internal combustion engine unit to thereby form the implement as claimed in claim 1.

9. A garden implement assembled by the method as claimed in claim 8.
